(19) United States
(12) Patent Application Publication
(10) Pub. No.: US 2012/0177492 A1
(43) Pub. Date: Jul. 12, 2012

(54) WIND TURBINE

(75) Inventors: Ulrich Schomakers, Wietmarschen (DE); Hendrik Wensing, Isterberg (DE)

(73) Assignee: SSB Wind Systems GmbH & Co. KG, Salzbergen (DE)

(21) Appl. No.: 13/395,772

(22) PCT Filed: Sep. 12, 2010
(86) PCT No.: PCT/EP2010/063336

§ 371 Date: Mar. 13, 2012

(30) Foreign Application Priority Data
Sep. 17, 2009 (DE) 10 2009 044 036.4

(51) Int. Cl. F03D 7/04; F03D 1/06

(52) U.S. Cl. 416/9

(57) ABSTRACT

Disclosed is a wind turbine having a nacelle (20), a rotor (1) that is mounted on the nacelle (20) so as to be rotatable about a rotor axis (12). The rotor (1) includes a rotor hub (2) and multiple rotor blades (3, 4, 5), each of which extends in the direction of a blade axis (13, 14, 15) running transversely or substantially transversely to the rotor axis (12) and is mounted on the rotor hub (2) so as to be rotatable about the respective blade axis (13, 14, 15). The rotor (1) further includes at least one switchgear cubicle (9, 10, 11) per rotor blade (3, 4, 5). An electric circuit (23, 24, 25) for actuating at least one blade angle adjustment drive (26, 27, 28), by means of which the respective rotor blade (3, 4, 5) can be rotated about the blade axis (13, 14, 15) thereof, is arranged in said at least one switchgear cabinets (9, 10, 11). The switchgear cabinets (9, 10, 11) are combined to form a compact switchgear cabinet assembly (22) which sits radially centered within the rotor hub (2).

The present invention relates to a wind turbine with a nacelle, a rotor that is rotatably mounted on the nacelle about a rotor axis and includes a rotor hub and a plurality of rotor blades, each of which extends in the direction of a blade axis running transversely or substantially transversely to the rotor axis, about which blade axis the respective rotor blade is rotatably mounted on the rotor hub, and at least one switchgear cabinet per rotor blade, in which is arranged an electrical circuit for actuating at least one blade angle adjustment drive, by means of which the respective rotor blade is rotatable about its blade axis.

A wind turbine with a rotor on the rotor hub of which a plurality of rotor blades are rotatably mounted about their axis is known from DE 10 2007 016 023 A1. A switchgear cabinet with an accumulator is arranged in the rotor hub, which can be connected via a switch to an electric motor for adjusting the pitch angle of one of the rotor blades.

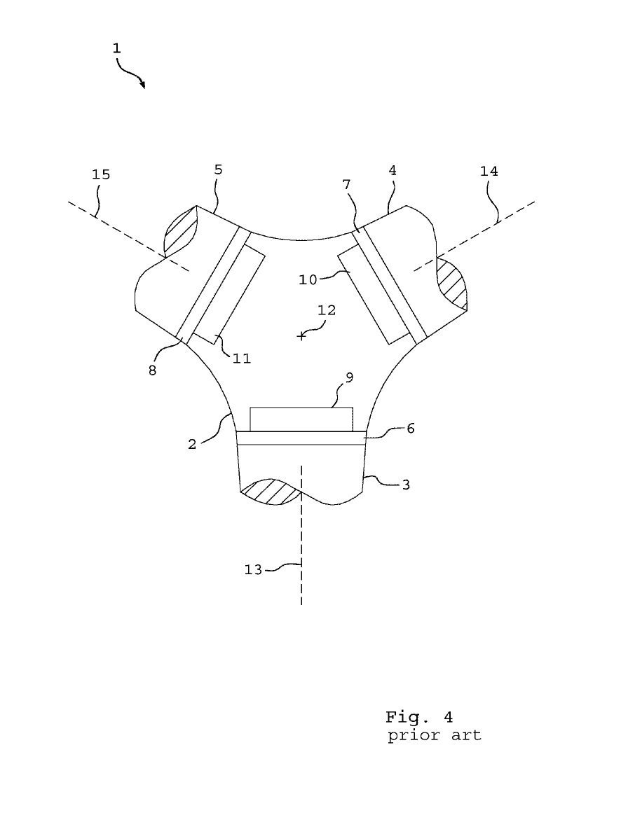

Such switchgear cabinets (pitch switchgear cabinets) are nowadays fixed in the region of the blade bearings of the wind turbine, as can be seen from FIG. 4, which shows a rotor 1 with a rotor hub 2 and a plurality of rotor blades 3, 4 and 5 fixed to the rotor hub 2, a blade bearing 6, 7 and 8 being associated with each of the rotor blades, by means of which the respective rotor blade is rotatably mounted on the hub 2. In addition a switchgear cabinet 9, 10 and 11, arranged in the region of the respective blade bearing, is associated with each rotor blade 3, 4 and 5. The rotor axis 12 about which the rotor 1 rotates extends according to FIG. 4 into the plane of the blade. The blade axis 13, 14 and 15, about which the respective rotor blades are rotatable relative to the hub 2, runs transversely to the rotor axis 12.

The disadvantage of this arrangement is that the design of the switchgear cabinets has to be adapted to the rotor hub. Since the hubs of wind turbines differ greatly in practice, this adaptation leads to a not inconsiderable effort and expenditure.

Against this background the object of the invention is to be able to design the switchgear cabinets largely independently of the shape of the rotor hub in a wind turbine of the type mentioned in the introduction.

This object is achieved according to the invention with a wind turbine according to claim 1. Preferred developments of the invention are disclosed in the subclaims.

The wind turbine according to the invention comprises a nacelle, a rotor that is rotatably mounted on the nacelle about a rotor axis and includes a rotor hub and a plurality of rotor blades, each of which extends in the direction of a blade axis running transversely or substantially transversely to the rotor axis, about which blade axis the respective rotor blade is rotatably mounted on the rotor hub, and at least one switchgear cabinet per rotor blade, in which is arranged an electrical circuit for actuating at least one blade angle adjustment drive, by means of which the respective rotor blade is rotatable about its blade axis, wherein the switchgear cabinets are assembled to form a compact switchgear cabinet arrangement located radially centrally in the rotor hub.

In the wind turbine according to the invention the switchgear cabinets are located radially centrally or approximately radially centrally in the rotor hub, so that the switchgear cabinets are arranged spaced from the blade bearings. Provided that the switchgear cabinets fit in the rotor hub, the shape and size of the rotor hub can vary without having to adapt the switchgear cabinet design. A uniform switchgear cabinet design for different rotor hubs can thus be achieved, resulting in a noticeable reduction in cost. Since the hub centre in conventional wind turbines is as a rule free, the conversion of the arrangement of the switchgear cabinets according to the invention also does not present any problems in practice. The term “radially” is understood to mean a direction running perpendicular or substantially perpendicular to the rotor axis.

The switchgear cabinets are in particular fixed in and/or on the rotor hub. Preferably the switchgear cabinets are fixed centrally in the rotor hub. Preferably the switchgear cabinets contact one another, so that a particularly compact switchgear cabinet arrangement can be created. In particular the switchgear cabinets are electrically conductive connected to one another in the contact region. For example, the switchgear cabinets consist of an electrically conducting material. The switchgear cabinets preferably consist of metal, in particular of stainless steel, powdered steel or of another material that is suitable for use in wind turbines.

According to one configuration of the invention the electrical circuits are electrically connected to one another by means of at least one electrical connection preferably passing through the contact region. The electrical connection can include one or a plurality of electrical leads and/or one or a plurality of electrical plug-in connections. Furthermore, in the contact region holes can be provided in the walls of the switchgear cabinets, through which the electrical connections, in particular in the form of electrical leads, can extend.

The electrical circuits preferably include in each case an electrical control mechanism for controlling the respectively associated blade angle adjustment drive. Each of the blade angle adjustment drives is preferably electrically designed and includes in particular one or a plurality of electric motors.

Preferably the switchgear cabinets form an arrangement surrounding and enclosing the rotor axis. In this way it is possible to arrange the switchgear cabinets in a very space-saving manner. In particular the switchgear cabinets are connected and/or fastened to one another.

The switchgear cabinets can in each case form a separate structural unit, which in particular is manufactured separately. Alternatively the switchgear cabinet arrangement is formed by a container accommodating the switchgear cabinets, whose interior is subdivided in particular by partitions into a plurality of regions, which form the switchgear cabinets. The partitions provided in the interior of the container thus serve as walls of the switchgear cabinets and at the same time separate the switchgear cabinets from one another. The container forms in this sense a “master” switchgear cabinet. According to a development the partitions form, in particular together with the wall of the container, a honeycomb structure, the honeycombs thereof in particular form the switchgear cabinets.

The invention permits a uniform design for the switchgear cabinets, and specifically largely independent of the number of rotor blades and the hub design, so that the production costs can be reduced. Preferably all switchgear cabinets have the same shape, for example a polygonal shape; in particular the switchgear cabinets have in each case a trapezoidal shape in a plane transverse to the rotor axis. This shape is particularly suitable for implementing the arrangement surrounding and enclosing the rotor axis.

A plurality of switchgear cabinets can be provided for each rotor blade. Preferably however precisely one switchgear cabinet is provided for each rotor blade. The number of switchgear cabinets is preferably three. Alternatively the number of switchgear cabinets can however also be two or more than three.

Since the arrangement formed by the switchgear cabinets is fixed radially centrally in the rotor hub, the cabinets can be designed independently of the configuration of the hub. Furthermore, due to the central arrangement the switchgear cabinets are subjected to a smaller centrifugal force. Due to the compact arrangement of the switchgear cabinets smaller material thicknesses can in addition be employed. In this way it is possible to make savings in material, weight and cost. The central arrangement of the switchgear cabinets also improves the accessibility of the blade bearings, the drives and the switchgear cabinets for service personnel. Since the switchgear cabinets preferably directly contact one another, external cable connections can largely be dispensed with. In particular the number of cable runs in the hub can be reduced.

The invention is described in more detail hereinafter with the aid of preferred exemplary embodiments and with reference to the accompanying drawings, in which:

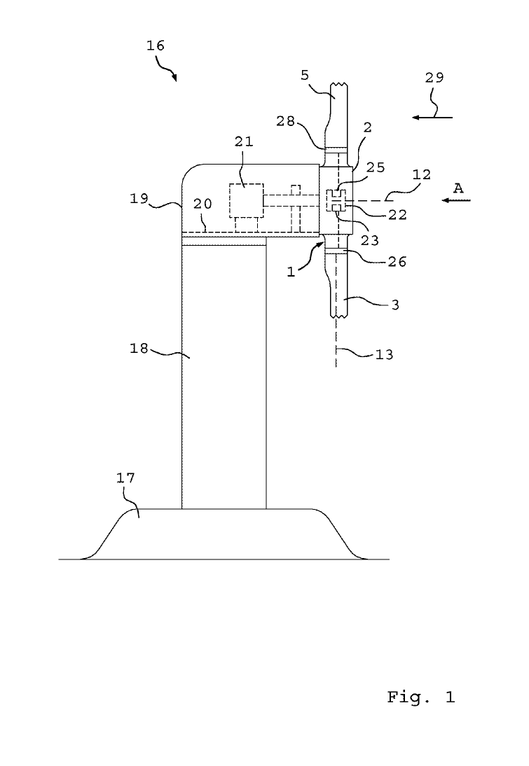

FIG. 1 is a schematic illustration of a wind turbine according to a first embodiment of the invention,

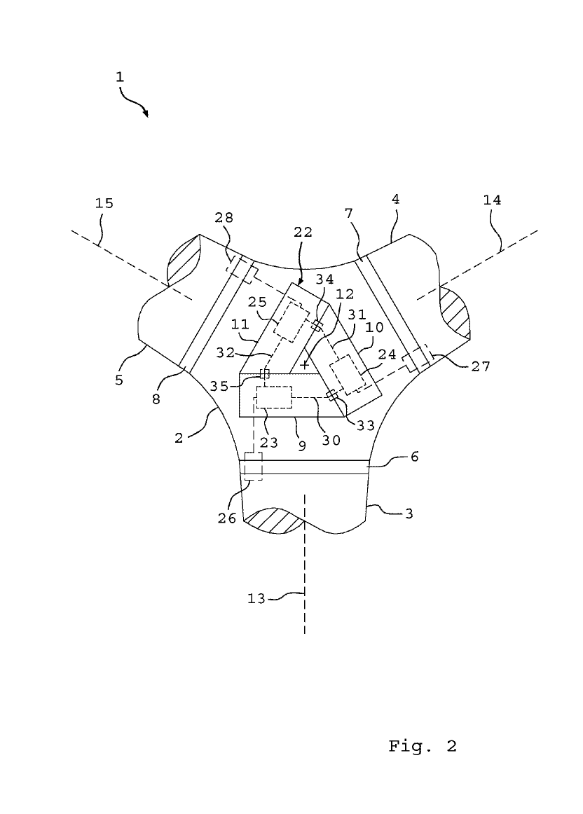

FIG. 2 is a plan view of the rotor according to FIG. 1 in the direction of the arrow A,

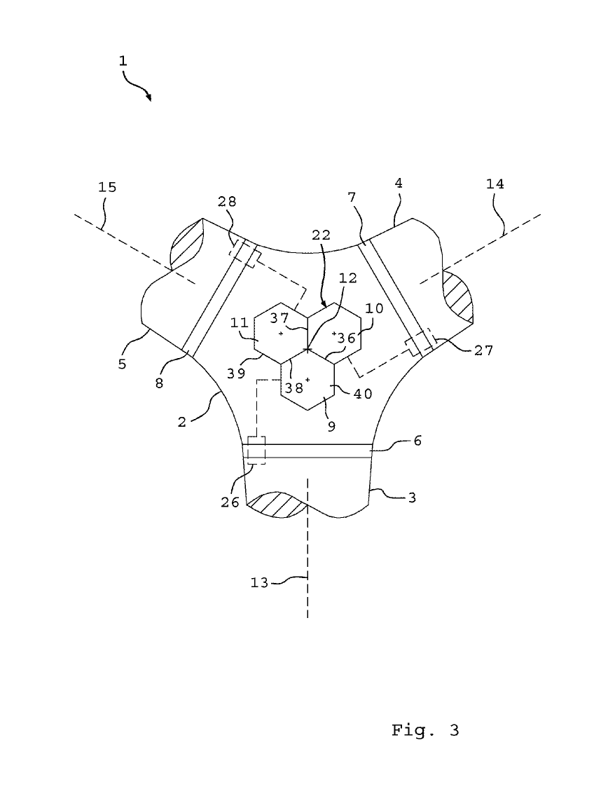

FIG. 3 is a plan view of a rotor according to a second embodiment of the invention, and

FIG. 4 is a plan view of a conventional rotor.

A schematic view of a wind turbine 16 according to a first embodiment of the invention can be seen from FIG. 1, wherein the wind turbine 16 comprises a tower 18 standing on a foundation 17, a machine housing 19 being arranged on the end of the tower remote from the foundation 17. The machine housing 19 comprises a nacelle 20, on which a rotor 1 is rotatably mounted about a rotor axis 12, the rotor comprising a rotor hub 2 and a plurality of rotor blades 3, 4 and 5 connected thereto. The rotor 1 is mechanically coupled to an electrical generator 21, which is arranged in the machine housing 19 and is fixed to the nacelle 20.

A switchgear cabinet arrangement 22, which is composed of a plurality of switchgear cabinets 9, 10 and 11, is fixed in the rotor 1. The switchgear cabinets 9, 10 and 11 include in each case an electrical control device 23, 24 and 25, the control devices 23, 24 and 25 being electrically connected in each case to a blade angle adjustment drive 26, 27 and 28. By means of the blade angle adjustment drives 26, 27 and 28 the rotor blades 3, 4 and 5 are rotatable about their respective blade axis 13, 14 and 15 relative to the rotor hub 2, one of the blade angle adjustment drives being associated with each rotor blade. The rotor blades 3, 4 and 5 are rotatably mounted by means of blade bearings 6, 7 and 8 on the rotor hub 2 about their respective blade axis 13, 14 and 15. The rotor 1 is rotated about the rotor axis 12 by wind power 29.

A plan view of the rotor 1 is shown in FIG. 2, from which it can be seen that the switchgear cabinets 9, 10 and 11 are identically configured and in each case have a trapezoidal shape in a plane running transverse to the rotor axis 12. The switchgear cabinets 9, 10 and 11 consist of metal and are in electrically conductive contact with one another, since the switchgear cabinets touch one another. In addition the electrical control devices 23, 24 and 25 are connected to one another via electrical leads 30, 31 and 32, which are preferably led through the regions in which the switchgear cabinets touch one another. Since the switchgear cabinets 9, 10 and 11 form separate structural parts that are assembled to form the switchgear cabinet arrangement 22, the electrical leads 30, 31 and 32 preferably include plug-in connectors, which are provided for example on the walls of the switchgear cabinets. In addition or alternatively the electrical leads can however also pass through holes provided in the walls of the switchgear cabinets 9, 10 and 11. The plug-in connectors and/or holes are simply indicated and identified by the reference numerals 33, 34 and 35.

From FIG. 2 it can be seen that the switchgear cabinet arrangement 22 sits radially centrally in the rotor hub and is surrounded by an annular free space, so that the switchgear cabinets are spaced from the blade bearings 6, 7 and 8. It can also be seen that the switchgear cabinet arrangement 22 forms an arrangement surrounding and enclosing the rotor axis 12.

FIG. 3 shows a plan view of a rotor 1 according to a second embodiment of the invention, wherein features similar or identical to the first embodiment are identified by the same reference numerals as in the first embodiment. In contrast to the first embodiment the switchgear cabinet arrangement 22 has a honeycomb structure, the honeycombs thereof form the switchgear cabinets 9, 10 and 11. The walls 36, 37 and 38 of the switchgear cabinets 9, 10 and 11 form inner walls, which are arranged in an interior 40 of a container delimited by a surrounding outer wall 39, the said container forming the switchgear cabinet arrangement 22 and being arranged radially centrally in the rotor hub 2. Alternatively the switchgear cabinets 9, 10 and 11 can however also form separate units, which are fixed to one another. As regards the further description of the second embodiment reference is made to the description of the first embodiment. The rotor according to the second embodiment can replace the rotor according to the first embodiment in the wind turbine according to FIG. 1.

### LIST OF REFERENCE NUMERALS

1 Rotor
2 Rotor hub
3 Rotor blade
4 Rotor blade
5 Rotor blade
6 Blade bearing
7 Blade bearing

8 Blade bearing
9 Switchgear cabinet
10 Switchgear cabinet
11 Switchgear cabinet
12 Rotor axis
13 Blade axis
14 Blade axis
15 Blade axis
16 Wind turbine
17 Foundation
18 Tower
19 Machine housing
20 Nacelle
21 Electrical generator
22 Switchgear cabinet arrangement
23 Control device
24 Control device
25 Control device
26 Blade angle adjustment drive
27 Blade angle adjustment drive
28 Blade angle adjustment drive
29 Wind
30 Electrical lead
31 Electrical lead
32 Electrical lead
33 Plug-in connector/hole
34 Plug-in connector/hole
35 Plug-in connector/hole
36 Inner wall
37 Inner wall
38 Inner wall
39 Outer wall
40 Interior

1-14. (canceled)

15. A wind turbine comprising a nacelle, a rotor that is rotatably mounted on the nacelle about a rotor axis, the rotor including a rotor hub and a plurality of rotor blades, each of which extends in the direction of a blade axis running substantially transversely to the rotor axis, about which blade axis the respective rotor blade is rotatably mounted on the rotor hub, and at least one switchgear cabinet per rotor blade, in which is arranged an electrical circuit for actuating at least one blade angle adjustment drive, by means of which the respective rotor blade is rotatable about its blade axis, wherein the switchgear cabinets are assembled to form a compact switchgear cabinet assembly located radially centrally in the rotor hub.

16. The wind turbine according to claim 15, wherein the switchgear cabinets contact one another in a contact region.

17. The wind turbine according to claim 16, wherein the electrical circuits are electrically connected to one another by means of at least one electrical connection passing through the contact region.

18. The wind turbine according to claim 15, wherein the switchgear cabinets are connected to one another in an electrically conducting manner.

19. The wind turbine according to claim 15, wherein the switchgear cabinets comprise metal switchgear cabinets.

20. The wind turbine according to claim 19, wherein the metal switchgear comprises a metal selected from the group consisting of stainless steels or powdered steels or combinations thereof.

21. The wind turbine according to claim 15, wherein the switchgear cabinet assembly comprises the switchgear cabinets assembled so as to surround and enclose the rotor axis.

22. The wind turbine according to claim 21, wherein the switchgear cabinet assembly further comprises a container whose interior is subdivided by partitions into a plurality of regions that form the switchgear cabinets.

23. The wind turbine according to claim 15, wherein all switchgear cabinets have the same shape.

24. The wind turbine according to claim 23, wherein the switchgear cabinets have a polygonal shape in a plane transverse to the rotor axis.

25. The wind turbine according to claim 24, wherein the switchgear cabinets have a trapezoidal shape in a plane transverse to the rotor axis.

26. The wind turbine according to claim 15, further comprising three switchgear cabinets.

27. The wind turbine according to claim 15, wherein each of the electrical circuits comprises an electrical control mechanism for controlling the respectively associated blade angle adjustment drives.

28. The wind turbine according to claim 15, wherein the switchgear cabinet assembly is arranged centrally in the rotor hub with respect to the rotor axis.
